(19) United States
(12) Patent Application Publication
(10) Pub. No.: US 2024/0200337 A1
(43) Pub. Date: Jun. 20, 2024

(54) LOUVERED AWNING STRUCTURE

(71) Applicant: Linhai Sunrise Leisure Products Co.,Ltd., Linhai City (CN)

(72) Inventors: Huaqiang Shen, Linhai City (CN); Yilun Liu, Linhai City (CN)

(21) Appl. No.: 18/590,996

(22) Filed: Feb. 29, 2024

(30) Foreign Application Priority Data
Jan. 23, 2024 (CN) 202420166334.5

(51) Int. Cl. E04F 10/10; A47H 1/04; E06B 9/28; E06B 9/42; F21S 9/03; F21V 33/00

(52) U.S. Cl. CPC E04F 10/10; A47H 1/04; E06B 9/28; E06B 9/42; F21S 9/035; F21V 33/006

(57) ABSTRACT

Disclosed is a louvered awning structure including an awning structure and a plurality of support columns, where a side curtain is mounted on the awning structure, a shaft body on the louver of the awning structure is pivotally connected to the pivot portion; the pivot portion includes an inlet passage, a pivot hole and a communication passage, and the shaft body is pivotally connected into the pivot hole via the inlet passage and the communication passage, which enhances the use effect of the louvered awning, and makes mounting of the louver relatively convenient.

### TECHNICAL FIELD

The present invention relates to the technical field of outdoor equipment, and in particular relates to a louvered awning structure.

### BACKGROUND

The louvered awning, known as a building having a hardware structure, is commonly used for a single house with a yard. In addition, the building provides people with functions of shading sunlight, blocking ultraviolet radiation, shading wind and rain for outdoor recreation. At present, a louvered awning includes an awning and a support column mounted on the awning, where the awning has a plurality of flipping louvers, and when the louvers are in a horizontal state, a shading effect is achieved, and when the louvers are in an inclined or vertical state, the shading effect fails; however, the louvered awning in the prior art has the following defects:
1. Only a top shading effect is provided, so that sunlight or wind and rain enter from a side of the louvered awning, so that people under the awning who are resting will also be affected by sunlight or wind or rain coming from the side, so that the resting experience is greatly spoiled, and the use effect is poor;
2. The shaft body on the louver is mounted in a closed pivot hole at the inner side of the cross beam, and therefore the louver is mounted after two opposite cross beams are positioned, and at this time, it is necessary to simultaneously adjust the distance between the two opposite cross beams with unite of several persons in a concerted effort, resulting in very complicated mounting and low mounting efficiency.

### SUMMARY

In view of the deficiencies of the prior art, it is an objective of the present invention to provide a louvered awning structure which is easy to mount and improves the efficiency of the louver mounting.

In order to achieve the above objective, the present invention provides the following technical solutions:
the present invention provides a louvered awning structure including an awning structure and a plurality of support columns, where the awning structure includes a frame and a plurality of louvers arranged side by side, the plurality of support columns are mounted on the frame, so that the awning structure is in an overhead state due to being supported by the plurality of support columns, the frame includes at least one first cross beam, and two oppositely arranged second cross beams, and a side curtain is mounted on the first cross beam or at least one of the second cross beams; the plurality of louvers are located between the two second cross beams, two ends of each of the louvers are respectively close to inner walls of the two second cross beams; a plurality of pivot portions arranged at intervals are formed on the inner walls of the two second cross beams; shaft bodies at the two ends of each of the louvers are respectively pivotally connected to the pivot portions of the two second cross beams; each pivot portion on at least one of the second cross beams includes an inlet passage and a pivot hole pivotally connected to the shaft body on the louver; and a communication passage respectively communicating with the inlet passage and the pivot hole, the communication passage is provided with a first communication port and a second communication port distributed up and down and arranged in a staggered manner, and the inlet passage and the pivot hole are respectively arranged at the first communication port and the second communication port, so that the inlet passage and the pivot hole are arranged in a staggered manner with respect to each other.

Advantageous effects of the louvered awning according to the present invention are as follows:
1. With the arrangement of the side curtains, the louvered awning can also shade sunlight, wind or rain coming from the side, thereby improving the use effect of the louvered awning.
2. When the side curtains are mounted, after the side curtains and the cross beams are close to each other, and after the second clamping portion is located in the clamping region, the first clamping portion and the second clamping portion are snap-fitted with each other, and then the first connecting portion and the second connecting portion are connected via a fastener, the mounting method makes the mounting of the side curtains easier and improves the mounting efficiency; and since the side curtains play a role of pre-positioning by the mutual clamping of the first clamping portion and the second clamping portion in advance, the mounting can be completed by only one person.
3. The inlet passage and the communication passage are provided in communication with the pivot hole, so that after the position of the second cross beam is fixed, only the shaft bodies at the two ends of each of the louvers are pivotally connected to the pivot hole via the inlet passage and the communication passage, and the operation can be performed by a single person, thereby facilitating the mounting of the louvers, and at the same time improving the mounting efficiency.
4. For an upper side inner wall of the communication passage being located above the pivot hole, and the arrangement of the recess and the blocking portion in the pivot hole, the shaft body pivotally connected into the pivot hole cannot be easily disengaged from the pivot portion, further improving the stability after mounting.

### BRIEF DESCRIPTION OF THE DRAWINGS

FIG. 1 is a schematic diagram showing an overall assembly of a louvered awning mounted with a pull-type rolling curtain;

FIG. 2 is a partial schematic structural diagram showing a support column;

FIG. 3 is a schematic structural diagram showing an awning structure in which a first cross beam and a second cross beam are connected;

FIG. 4 is a schematic diagram (I) showing mounting a mount on a cross beam;

FIG. 5 is a schematic structural diagram showing mounting a pull-type roll on a cross beam via a mount;

FIG. 6 is a schematic structural diagram showing that a pull-type roll is to be mounted on a cross beam via a mount;

FIG. 7 is a schematic structural diagram (II) showing mounting a mount on a cross beam;

FIG. 8 is a schematic diagram (I) showing mounting a mount on a cross beam having a cloth curtain hanging rail;

FIG. 9 is a schematic structural diagram showing mounting a pull-type roll on a cross beam having a cloth curtain hanging rail via a mount;

FIG. 10 is a schematic diagram (II) showing mounting a mount on a cross beam with a cloth curtain hanging rail;

FIG. 11 is a schematic diagram showing an overall assembly of a louvered awning mounted with a venetian blind;

FIG. 12 is a partial schematic structural diagram (I);

FIG. 13 is a partial schematic structural diagram (II);

FIG. 14 is a schematic diagram showing an overall assembly of a louvered awning mounted with a rail-type curtain;

FIG. 15 is a schematic structural diagram showing hooks on a cross beam having cloth curtain hanging rails;

FIG. 16 is another schematic structural diagram showing the rail-type curtain;

FIG. 17 is a schematic diagram showing an overall assembly of an awning;

FIG. 18 is an enlarged view at A;

FIG. 19 is an enlarged view at B;

FIG. 20 is a schematic structural diagram (I) showing a second cross beam;

FIG. 21 is a schematic structural diagram (II) showing a second cross beam;

FIG. 22 is another schematic structural diagram showing a second cross beam;

FIG. 23 is a partial view of a communication passage of a pivot portion in an inclined arrangement;

FIG. 24 is a partial schematic structural diagram showing an awning;

FIG. 25 is a schematic structural diagram showing a louver;

FIG. 26 is a schematic structural diagram (I) showing a louver in a vertical state;

FIG. 27 is a schematic structural diagram (I) showing a louver in a horizontal state;

FIG. 28 is a schematic structural diagram (II) showing a louver in a vertical state;

FIG. 29 is a schematic structural diagram (II) showing a louver in a vertical state;

FIG. 30 is a schematic structural diagram showing a gear drive group;

FIG. 31 is a schematic structural diagram showing a turbine worm drive group;

FIG. 32 is a schematic structural diagram showing mounting a parasol gear drive group on a driving handle;

FIG. 33 is a schematic structural diagram showing assembly of two louvered awnings;

FIG. 34 is a schematic structural diagram showing assembly of three louvered awnings;

FIG. 35 is a schematic structural diagram (I) showing a cross-section of a louver;

FIG. 36 is a schematic structural diagram (II) showing a cross-section of a louver;

FIG. 37 is a schematic structural diagram (III) showing a cross-section of a louver;

FIG. 38 is a schematic structural diagram showing mounting of a link;

FIG. 39 is a schematic structural diagram showing an end of the louver;

FIG. 40 is a schematic structural diagram showing a louver having solar panels;

FIG. 41 is a schematic structural diagram showing a louver having a lighting device;

FIG. 42 is a schematic structural diagram showing mounting a guide rail on a support column; and

FIG. 43 is a partial enlarged view of FIG. 42.

### REFERENCE NUMERALS

100. awning structure; 101. frame; 102. first cross beam; 103. second cross beam; 104. cloth curtain hanging rail; 200. support column; 201. solar panel; 202. storage battery; 203. lighting device; 204. first connecting board; 205. second connecting board; 206. fixed connecting portion; 207. limiting slot; 208. limiting protrusion; 209. connecting block; 210. positioning groove; 211. clamping groove; 300. fastener; 400. guide rail; 401. first guide; 402. second guide; 403. first snap; 404. second snap; 405. first half groove; 406. second half groove 407. third half groove; 408. fourth half groove; 409. positioning protrusion; 410. clamping block; 411. positioning board; 412. first positioning insert slot; 413. first positioning insert block; 414. second positioning insert slot; 415. second positioning insert block; 416. rail slot; 417. positioning elongated groove; 500. venetian blind; 501. frame body; 600. mount; 601. first clamping portion; 602. first connecting portion; 603. clamping region; 604. spacer; 700. pull-type rolling curtain; 701. connecting groove; 702. second clamping portion; 703. second connecting portion; 704. curtain body; 705. zipper; 800. rail-type curtain; 801. hook; 802. cloth curtain; 11. beam body; 111. mounting piece; 112. baffle; 113. pivot portion; 114. inlet passage; 115. communication passage; 116. pivot hole; 117. recess; 118. blocking portion; 119. first communication port; 120. second communication port; 2. louver; 21. first hinge; 22. second hinge; 24. shaft body; 241. limiting body; 25. rolling sleeve; 26. elongated mounting groove; 27. mounting cavity; 28. stripped groove; 3. louver flipping driving device; 30. driving mechanism; 31. first connecting rod; 32. second connecting rod; 33. driving handle; 34. driving gear; 35. driven gear; 36. parasol gear; 37. worm; 38. turbine; 39. output shaft. 281. pin rod; 29. connecting board; 291. elongated sheet; 292. elongated baffle; 293. elongated tab; 294. buckle; 295. arc-shaped convex surface; 296. elongated groove; 297. elongated cover sheet; 4. link; 40. hinge hole; 230. connecting column; 231. pin hole; 282. elastomer ring.

### DESCRIPTION OF THE EMBODIMENTS

### Embodiments

The present embodiment describes a louvered awning structure mainly used for sunshade, sheltering from wind and rain, and the detailed structure is described as follows.

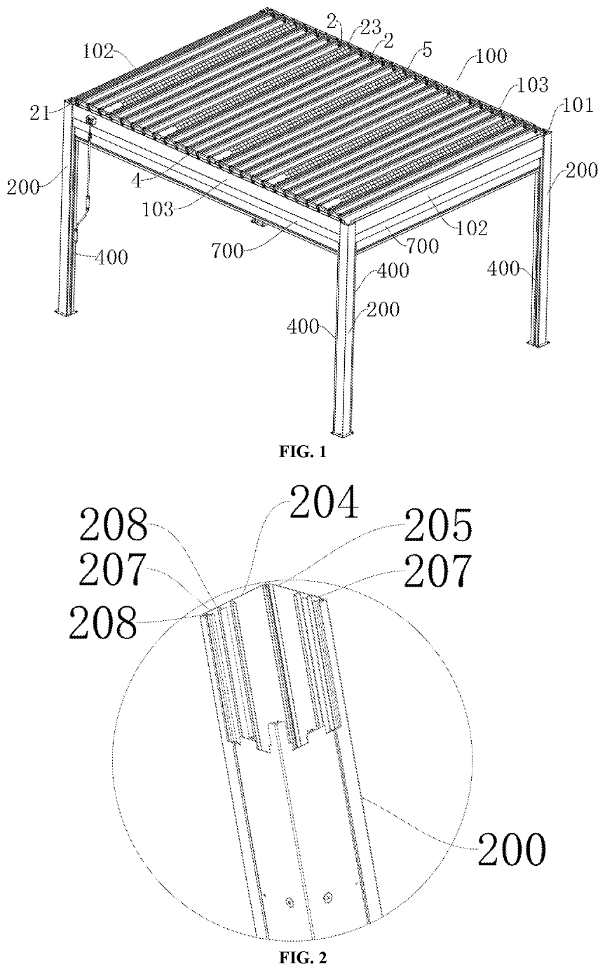

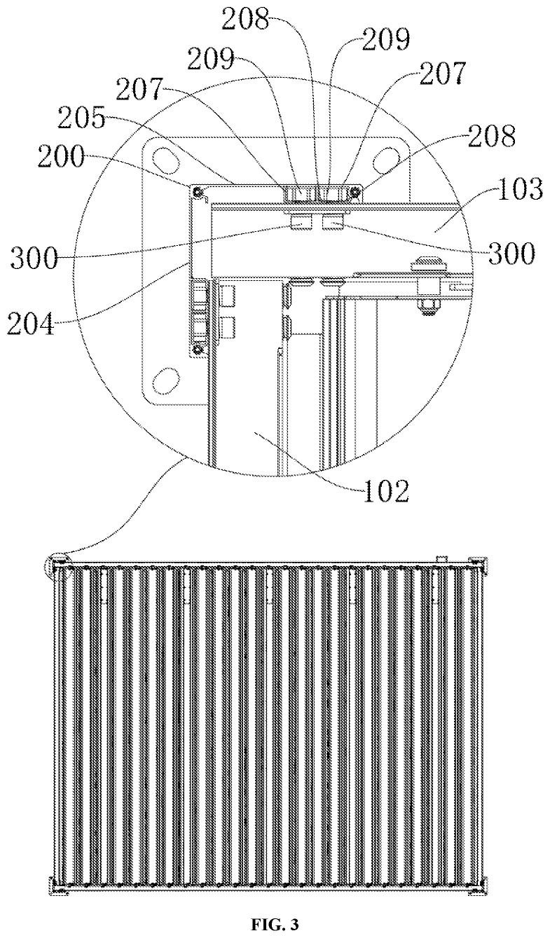

As shown in FIGS. 1-3, the louvered awning structure includes an awning structure 100 and a plurality of support columns 200, where the awning structure 100 includes a frame 101 and a plurality of louvers arranged side by side, the frame 101 includes at least one first cross beam 102 and two second cross beams 103 arranged opposite to each other, each support column 200 is arranged perpendicular to a support surface, a top end of each support column 200 is fixedly connected to an end of the first cross beam 102 and an end of the second cross beam 103 at the same time, each support column 200 is provided with a fixed connecting portion 206, and the first cross beam 102 and the second cross beam 103 are respectively arranged perpendicular to the support columns 200; the end of the first cross beam 102 and the end of the second cross beam 103 are placed on an end face of a top end of the support column 200, the top end of the support column 200 is provided with a first connecting board 204 and a second connecting board 205 arranged perpendicular to each other, the end of the first cross beam 102 and the end of the second cross beam 103 are respectively provided with a connecting face, the connecting face of the first cross beam 102 is close to an inner wall of the first connecting board 204, and the connecting face of the second cross beam 103 is close to an inner wall of the second connecting board 205; a limiting slot 207 is provided respectively on the inner wall of the first connecting board 204 and the inner wall of the second connecting board 205, a connecting block 209 is inserted into each limiting slot 207, a limiting protrusion 208 for limiting the connecting block 209 is formed on an edge of a notch of each limiting slot 207, an end of the first cross beam 102 is connected to the connecting block 209 on the first connecting board 204 via a fastener 300, and an end of the second cross beam 103 is respectively connected to the connecting block 209 on the second connecting board 205 via the fastener 300; so that the end of the first cross beam 102 and the end of the second cross beam 103 are fixed on the top end of the support column 200, the connecting face of the first cross beam 102 is arranged in parallel with the first connecting board 204, and the connecting face of the second cross beam 103 is arranged in parallel with the second connecting board 205, so that after the plurality of support columns 200 are mounted on the frame 101, the awning structure 100 is in an overhead state due to being supported by the plurality of support columns 200, where the connecting block 209 is provided with a plurality of threaded holes, the fastener 300 is a bolt, and the first cross beam and the second cross beam are provided with through-holes; therefore, a threaded rod of the bolt penetrates through the through-hole and is threadedly connected to the threaded hole of the connecting block 209 to fix the first cross beam and the second cross beam on the support column 200.

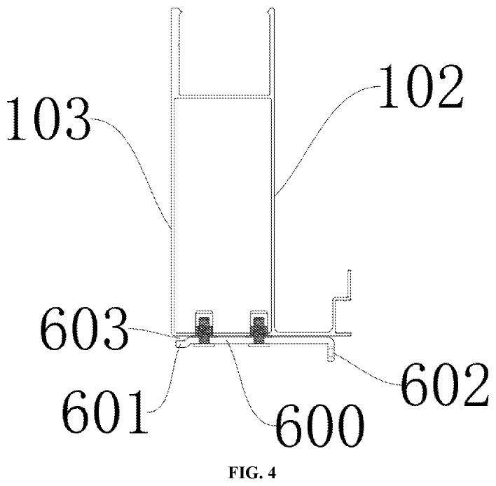

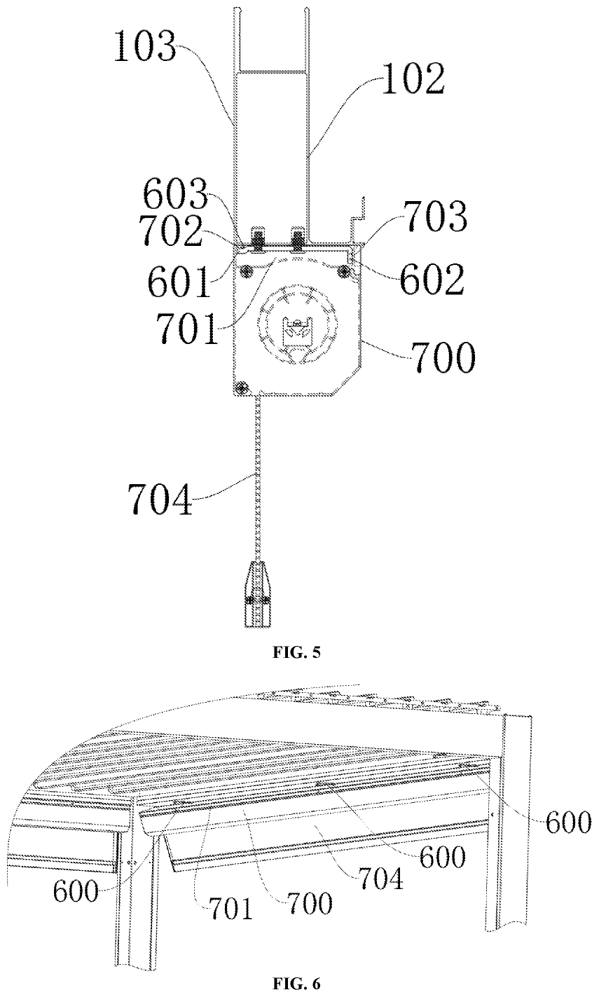

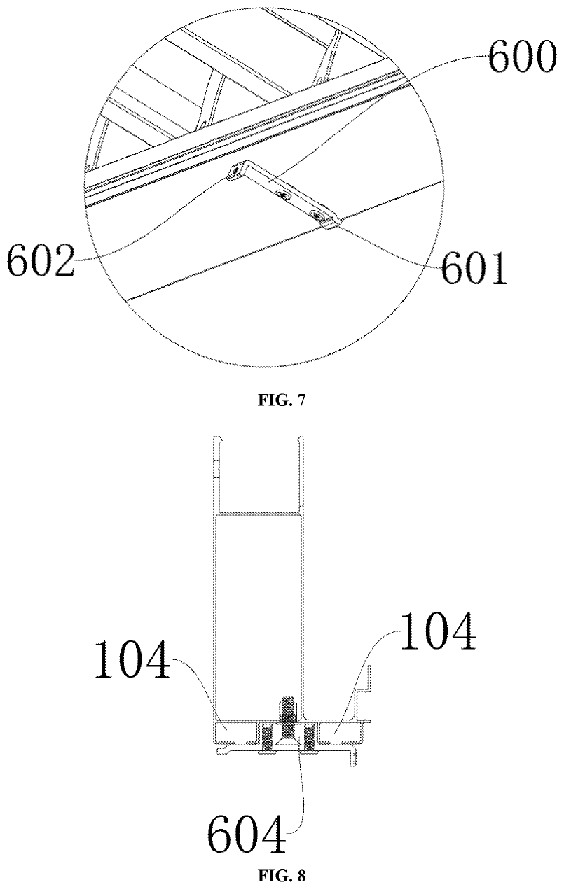

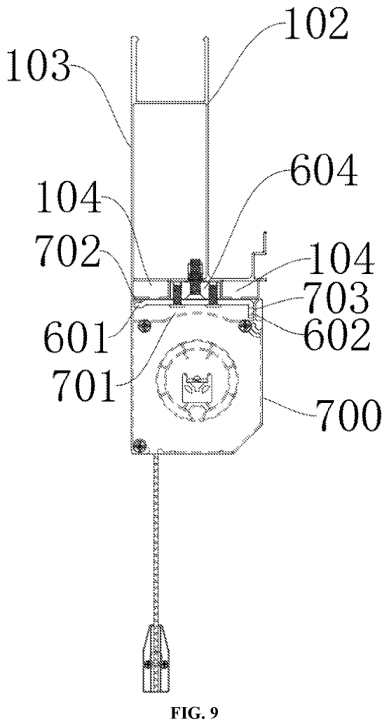

A side curtain is mounted on the first cross beam 102 or at least one of the second cross beams 103; specifically, as shown in FIGS. 4-10, a mount 600 is mounted at the connecting side of the first cross beam 102 or at least one of the second cross beams 103, the connecting side of the first cross beam 102 or at least one of the second cross beams 103 can be of a planar structure, and therefore a mount 600 can be directly fixed on the connecting side of the first cross beam or the second cross beam via bolts, or two cloth curtain 802 hanging rails 104 arranged along a length direction of the cross beams are provided at the connecting side of the first cross beam 102 or at least one of the second cross beams 103, and therefore, a spacer 604 is provided between the two cloth curtain 802 hanging rails 104 and is fixed to the cross beam via a bolt, the mount 600 is adhered to an outer wall of the spacer 604, and then the bolt passes through the mount 600 and the spacer 604 to be connected to the threaded hole of the cross beam; the two ends of the mount 600 are respectively provided with a first clamping portion 601 and a first connecting portion 602; the mount 600 is of a board structure, so that one end of the mount 600 is bent twice to form a clamping region 603 located at the first clamping portion 601 and located above the first clamping portion; the other end of the mount 600 is bent once at 90° to form the first connecting portion 602; the clamping region 603 is located between the first clamping portion 601 and the first cross beam 102 or the second cross beam 103; and a connecting groove 701 is provided at the connecting side of the side curtain; a second clamping portion 702 and a second connecting portion 703 are formed on two opposite inner walls of the connecting groove 701; the mount 600 is located in the connecting groove 701; after the second clamping portion 702 is located in the clamping region 603, the first clamping portion 601 and the second clamping portion 702 are snap-fitted with each other; the first connecting portion 602 is fixedly connected to the second connecting portion 703 via the fastener 300, where the fastener 300 is a bolt; a threaded hole is provided on the first connecting portion 602, and the second connecting portion 703 is a through-hole corresponding to the threaded hole. Therefore, the threaded rod of the bolt penetrates through the through-hole and is threadedly connected with the threaded hole to fix the side curtain to the first cross beam or the second cross beam, where the first cross beam 102 and the second cross beam 103 are arranged perpendicularly to each other.

One or two first cross beams 102 can be provided, and when there are two first cross beams 102, they are respectively fixed at two ends of the second cross beam 103 to form a louvered awning having four cross beams; or when there is one first cross beam 102, two ends of the one first cross beam 102 are respectively fixed between one end of the second cross beam 103 to form a louvered awning having three cross beams; however, the other ends of the two second cross beams 103 of the louvered awning can be respectively assembled and mounted with the two second cross beams 103 of the second louvered awning, and the second louvered awning can be a louvered awning having two second cross beams 103, and a third louvered awning can be continuously assembled, or can also be a louvered awning having three cross beams, where when the ends of the two second cross beams 103 are oppositely assembled and mounted, the top end of the support column 200 at the assembly and mounting part has only the second connecting board 205, so that the end of the second cross beam 103 is fixedly connected to the connecting block 209 of the second connecting board 205 via the fastener 300.

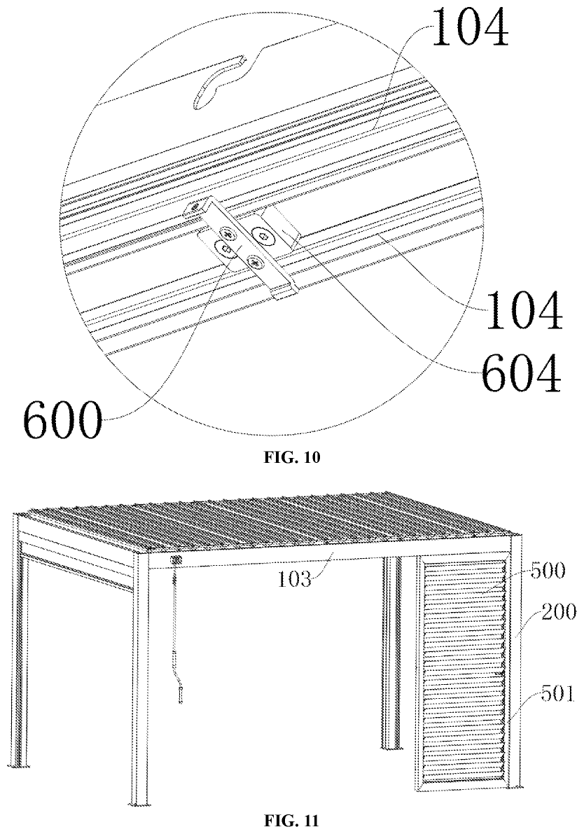

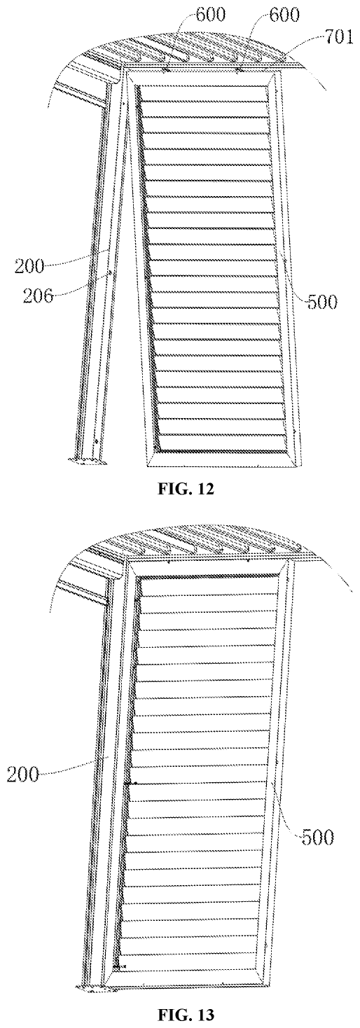

When the side curtain is a pull-type rolling curtain 700, a guide rail 400 is provided on a side of the support column 200 facing the side curtain, and the guide rail 400 is arranged in a vertical shape, a positioning protrusion 409 is provided on the side of the guide rail 400 facing the support column 200, a positioning groove 210 is provided on the side of the support column 200 facing the side curtain, the positioning protrusion 409 fits into the positioning groove 210 to play a role of pre-positioning to prevent the guide rail 400 from deviating from a pre-set mounting position, and after the pre-positioning, the guide rail 400 is connected to the fixed connecting portion 206 via the fastener, the plurality of fixed connecting portions 206 are provided, and the fixed connecting portions 206 are threaded holes, the fastener is a bolt, and the guide rail 400 is provided with a plurality of through-holes respectively corresponding to the position of each threaded hole, and therefore a threaded rod of the bolt penetrates through and is connected to the threaded hole to fix the guide rail 400 in a vertical manner on the support column 200, and at this time, a side of the curtain body 704 of the pull-type rolling curtain 700 is inserted into the rail slot 416 of the guide rail 400; thus, the curtain body 704 can move within the rail slot 416 of the guide rail 400, so that the curtain body 704 of the pull-type rolling curtain 700 can be pulled more stably, with reference to FIGS. 1, 42 and 43, or
when the side curtain is a venetian blind 500, a vertical side face of a frame body 501 on the venetian blind 500 is connected to the fixed connecting portion 206 on the support column 200 via a fastener 300, where the plurality of fixed connecting portions 206 are provided, and the fixed connecting portions 206 are threaded holes; the fastener 300 is a bolt; a plurality of through-holes corresponding to the position of each threaded hole are provided at the vertical side face of the frame body 501 on the venetian blind 500; therefore, a threaded rod of the bolt passes through and is connected to the threaded hole to fix the venetian blind 500 on the support column 200 in a vertical manner; and the venetian blind 500 is a known prior art, which therefore will not be described in detail herein, with reference to FIGS. 11-13.

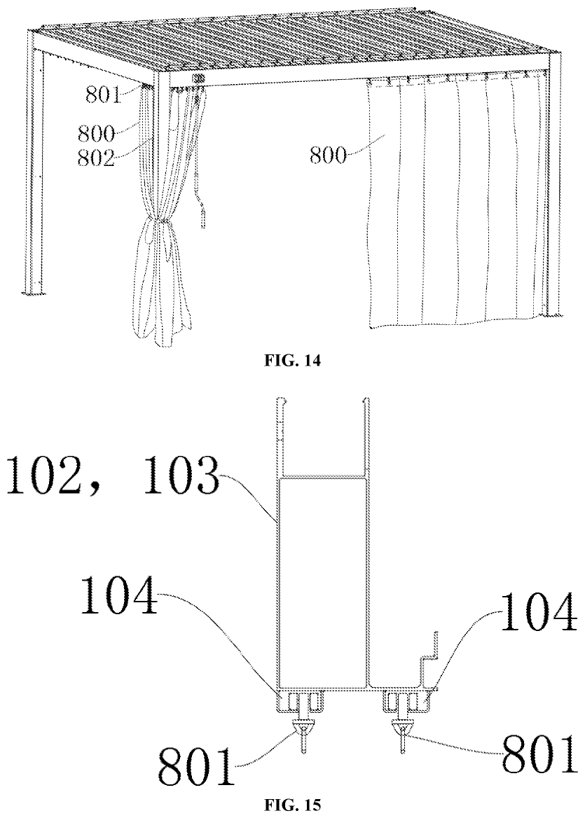

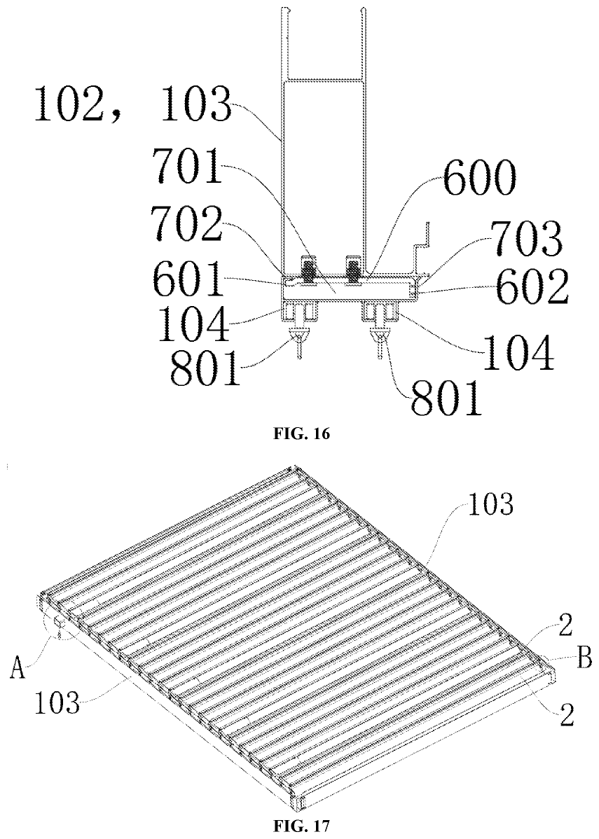

In another embodiment of the side curtain, the side curtain is a rail-type curtain 800 having a rail provided with a connecting groove 701 and a cloth curtain 802 hanging rail 104, an upper side of the cloth curtain 802 of the rail-type curtain 800 is slidably mounted in the groove of the cloth curtain 802 hanging rail 104 via hooks 801, or a connecting side of the first cross beam 102 or at least one of the second cross beams 103 itself is provided with two cloth curtain 802 hanging rails 104 arranged along a length direction of the cross beam, and then the cloth curtain 802 is required as a windproof curtain; the mount 600 is removable, and the plurality of hooks 801 for hanging the cloth curtain 802 can be hung in the groove of the cloth curtain 802 hanging rail 104, and an upper side of the cloth curtain 802 is connected to the hooks 801, with reference to FIGS. 14-16.

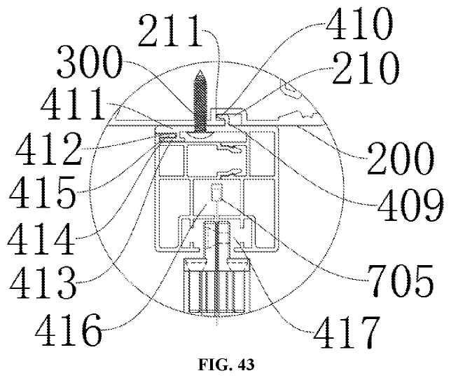

Further, as shown in FIGS. 42 and 43, a clamping groove 211 is formed on a side inner wall of the positioning groove 210, a clamping block 410 is formed on a front face of the positioning protrusion 409 facing the clamping groove 211 and is snap-fitted into the clamping groove 211, an opening width of the clamping groove 211 is greater than the distance between the end of the clamping block 410 and the back face of the positioning protrusion 409, and the structure thereof is arranged so that a relatively stable pre-positioning can be obtained when the guide rail 400 is mounted, and the guide rail 400 can be relatively stably fixed after the mounting is completed.

Preferably, as shown in FIGS. 42 and 43, the guide rail 400 includes a first guide 401 and a second guide 402, a first snap 403, a first half groove 405 and a second half groove 406 are provided at an inner side of the first guide 401, a second snap 404 corresponding to the position of the first snap 403, a third half groove 407 corresponding to the position of the first half groove 405 and a fourth half groove 408 corresponding to the position of the second half groove 406 are provided at an inner side of the second guide 402, the first guide 401 is provided with a first positioning body, a second positioning body is provided on the second guide 402; the first positioning body includes a positioning board 411, a first positioning insert block 413 and a first positioning insert slot 412; a positioning protrusion 409 and a through-hole are both provided on the positioning board 411; the second positioning body includes a second positioning insert block 415 and a second positioning insert slot 414; when the guide rail 400 is assembled, the positioning board 411 is adhered to the side face of the support column 200, at this moment, the positioning protrusion 409 is inserted into the positioning groove 210, and the clamping block 410 is snap-fitted into the clamping groove 211; then the threaded rod of the bolt penetrates through the through-hole and is in a threaded connection with the threaded hole on the support column 200, then the inner side of the first guide 401 and the inner side of the second guide 402 are in a state of being in contact with or close to each other, and the first snap 403 and the second snap 404 are fastened to each other, the first half groove 405 and the third half groove 407 are assembled to form a rail slot 416, the second half groove 406 and the fourth half groove 408 are assembled to form a positioning elongated groove 417, and an end of a strip of a bottom edge of the curtain body 704 of the pull-type rolling curtain 700 is inserted into the positioning elongated groove 417; the positioning protrusion 409 is provided on the first guide 401 or the second guide 402, the positioning board 411 is located above the second guide 402, the first positioning insert block 413 is correspondingly inserted into the second positioning insert slot 414, and the second positioning insert block 415 is correspondingly inserted into the first positioning insert slot 412.

Further preferably, a damping block is provided in the rail slot 416 and is provided with an elongated damping groove arranged vertically, and a zipper 705 on a side of the curtain body 704 is placed in the elongated damping groove to act on the elongated damping groove, so that the curtain body 704 can stay at any position, and the damping block can be a rubber block.

In the present embodiment, as shown in FIGS. 17-24, the plurality of louvers 2 are located between the two second cross beams 103 and are arranged adjacent to each other and in parallel, the two ends of the louvers 2 are respectively close to the inner walls of the two second cross beams 103, the inner walls of the two second cross beams 103 are both formed with a plurality of pivot portions 113 arranged at intervals, the positions of the plurality of louvers 2 are respectively arranged corresponding to the positions of the pivot portions 113 on each second cross beam 103, and the shaft bodies 24 at the two ends of each louver 2 are respectively pivotally connected to the pivot portions 113 of the two second cross beams 103. Each pivot portion on at least one second cross beam 103 includes an inlet passage 114, a pivot hole 116 pivotally connected to the shaft body 24 on the louver 2, and a communication passage 115 respectively communicating with the inlet passage 114 and the pivot hole 116, where the communication passage is provided with a first communication port 119 and a second communication port 120, the first communication port 119 and the second communication port 120 are distributed up and down and are arranged in a staggered manner, and the inlet passage 114 and the pivot hole 116 are respectively arranged at the first communication port 119 and the second communication port 120; so that the inlet passage 114 and the pivot hole 116 are arranged in a mutually offset manner; where it is possible that the pivot portion 113 of one second cross beam 103 is only a closed jack, and the pivot portion 113 on the other second cross beam 103 is composed of an inlet passage 114, a pivot hole 116 and a communication passage 115, so that when the louvers 2 are mounted, the shaft body 24 at one end of the louver 2 can be inserted into the closed jack first, and then the shaft body 24 at the other end is also pivotally connected into the pivot hole 116 via the inlet passage 114 and the communication passage 115 on the other second cross beam 103 to complete the mounting; or the pivot portions 113 on the two second cross beams 103 are each composed of an inlet passage 114, a pivot hole 116 and a communication passage 115; when the louvers 2 are mounted, the shaft body 24 at one end of the louver 2 is pivotally connected into the pivot hole 116 via the inlet passage 114 and the communication passage 115 on one second cross beam 103, and then the shaft body 24 at the other end is also pivotally connected into the pivot hole 116 via the inlet passage 114 and the communication passage 115 on the other second cross beam 103 to complete the mounting. It can be seen from the above that it is not necessary to adjust the spacing between the two second cross beams 103 during mounting, so that a single louver is convenient to mount and the operation can be completed only by a single person.

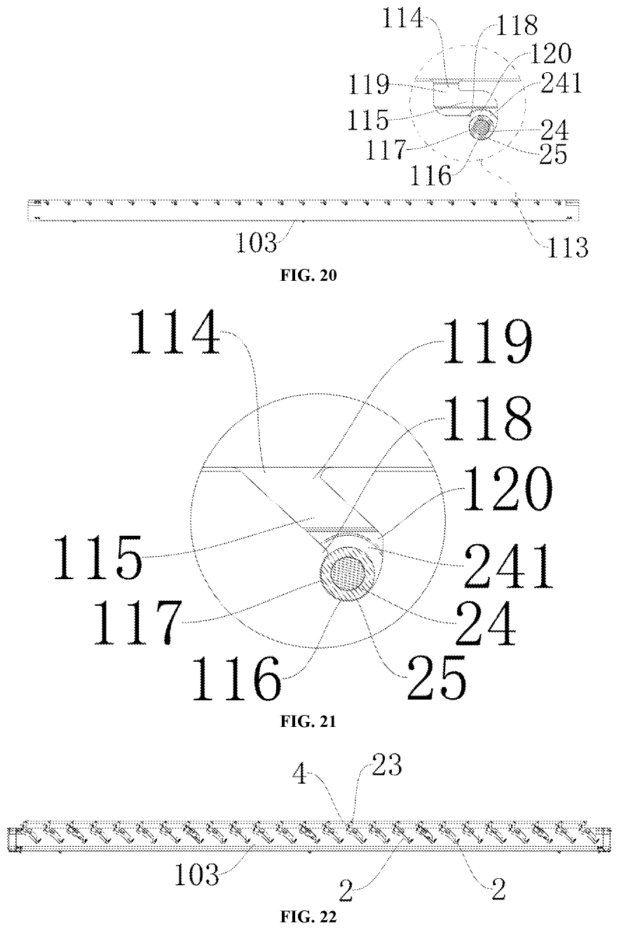

Specifically, the communication passage is provided horizontally along a length direction of the second cross beam 103 or the communication passage is provided obliquely; an upper side inner wall of the communication passage 115 is located above the pivot hole 116, and a lower side inner wall of the communication passage 115 is located below the inlet passage 114, with reference to FIGS. 20 and 21.

When the communication passage is in a horizontal state, the upper side inner wall of the communication passage 115 serves as a limiting wall for limiting the shaft body 24 on the louver 2 to prevent the louver from being lifted up due to the strong wind, thereby causing the shaft body 24 to disengage from the pivot portion 113.

Further, a recess 117 is formed on the pivot hole 116 at one side of the lower side inner wall of the communication passage 115 to cooperate with the shaft body 24 on the louver 2, and a blocking portion 118 is formed at an upper side of the recess 117, the inner wall of the pivot hole 116 is provided in a circular arc shape, so that the recess 117 is a circular arc-shaped recess 117, where in general, a cylindrical shaft body 24 is used as the shaft body 24, and the blocking portion 118 is a protruding structure protruding towards the inner wall of the opposite side of the recess 117 on the pivot hole 116, and therefore the shaft body 24 can be limited by the recess 117 and the blocking portion 118 after entering the pivot hole 116 to prevent the shaft body 24 from being disengaged, and achieve stable mounting of the shaft body 24, with reference to FIGS. 20 and 21.

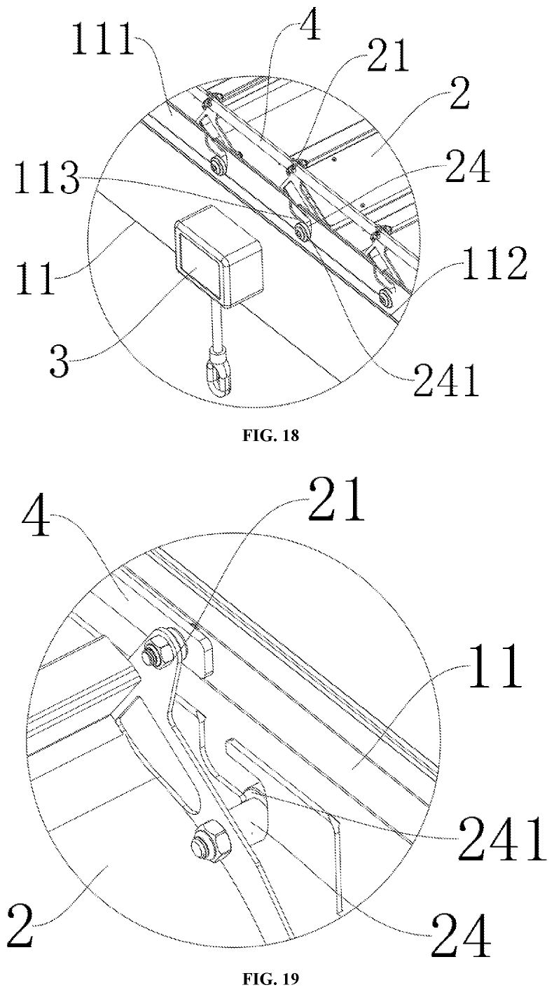

Further, the second cross beam 103 includes a beam body 11 and a mounting piece 111 arranged on the upper side face of the beam body 11, where the mounting piece 111 is arranged along the length direction of the beam body 11, a plurality of pivot portions 113 are arranged at equal intervals and are all arranged on the mounting piece 111, and the plurality of pivot portions 113 are linearly arranged along the length direction of the mounting piece 111, where the pivot portions 113 on the mounting piece 111 are generally three or more, and a width specification of each louver 2 is made equal by making the spacing between the respective pivot portions 113 equal, thereby facilitating the manufacture of the louvers 2, with reference to FIG. 18.

The upper side face of the beam body 11 is provided with a baffle 112 arranged along the length direction of the beam body 11 and located in the outer side direction of the mounting piece 111, the baffle 112 and the mounting piece 111 are arranged at intervals, the outer side face of the beam body 11 is arranged flush with the outer side face of the baffle 112, a drainage groove can be formed between the baffle 112 and the mounting piece 111 to guide rainwater to flow out towards the two ends of the beam body 11, thereby preventing rainwater from flowing down from the outer side faces of the two sides when raining and improving the use effect of the awning, and at the same time, a through-hole for the connection of the fastener 300 is provided on the baffle 112, with reference to FIG. 18.

Preferably, a limiting body 241 is provided on the shaft body 24 pivotally connected into the pivot hole 116 via the inlet passage 114 and the communication passage 115 on the louver 2, or a rolling sleeve 25 or a rolling wheel is sleeved on the shaft body 24 pivotally connected into the pivot hole 116 via the inlet passage 114 and the communication passage 115 on the louver 2, where the rolling sleeve 25 or the rolling wheel is movably mounted in the pivot hole 116, a limiting body 241 is provided on the rolling sleeve 25 or the rolling wheel, and a limiting member is mounted at the end of the shaft body 24 pivotally connected into the pivot hole 116 via the inlet passage 114 and the communication passage 115 on the louver 2 to limit the rolling sleeve 25 or the rolling wheel on the shaft body 24, where the rolling wheel or the rolling sleeve 25 is limited by the recess 117 and the blocking portion 118; when the mounting of the louvers 2 is completed, the two end faces thereof are respectively closer to the inner side walls of the two second cross beams 103, and the second cross beams 103 are fixed, and the end face of the shaft body 24 is located outside the mounting piece 111, so that the limiting body 241 is located outside the mounting piece 111, and the limiting body 241 may be a limiting convex ring arranged along the circumferential direction of the shaft body 24 or the rolling wheel or the rolling sleeve 25, and the limiting convex ring is generally arranged in contact with or close to the outside of the mounting piece 111 to limit the position of the louvers 2 after mounting and prevent the louvers 2 from moving axially, as shown with reference to FIGS. 19, 20 and 39.

In the present embodiment, as shown in FIGS. 17-19 and 22, the louvered awning further includes two links 4 and a louver flipping driving device 3, where the two links are arranged along a length direction of the second cross beam 103 and are respectively located above two ends of each of the louvers 2, a first hinge 21 at the two ends of each of the louvers 2 is respectively hinged with the two links 4, and the louver flipping driving device 3 is hinged with a second hinge 22 on one louver 2 of the louvered awning; the positions of the first hinges 21 at two ends of each of the louvers 2 are arranged corresponding to each other, and the first hinges 21 at two ends of each of the louvers 2 are arranged offset from a central axis thereof in the width direction of the louvers 2.

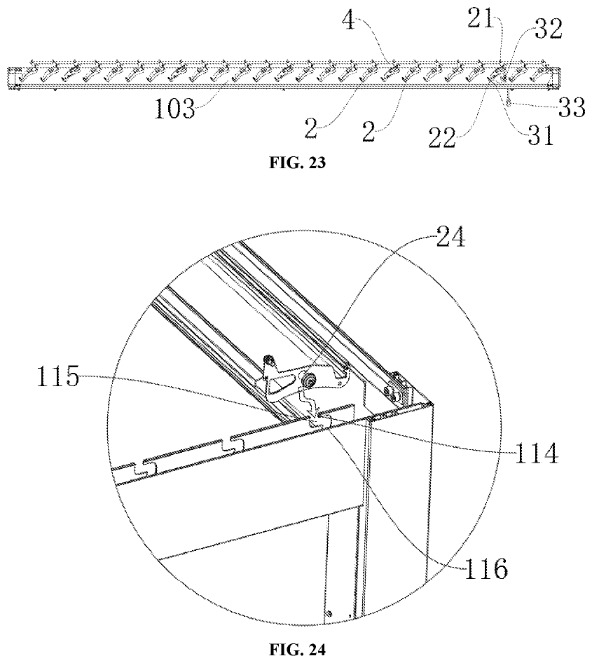

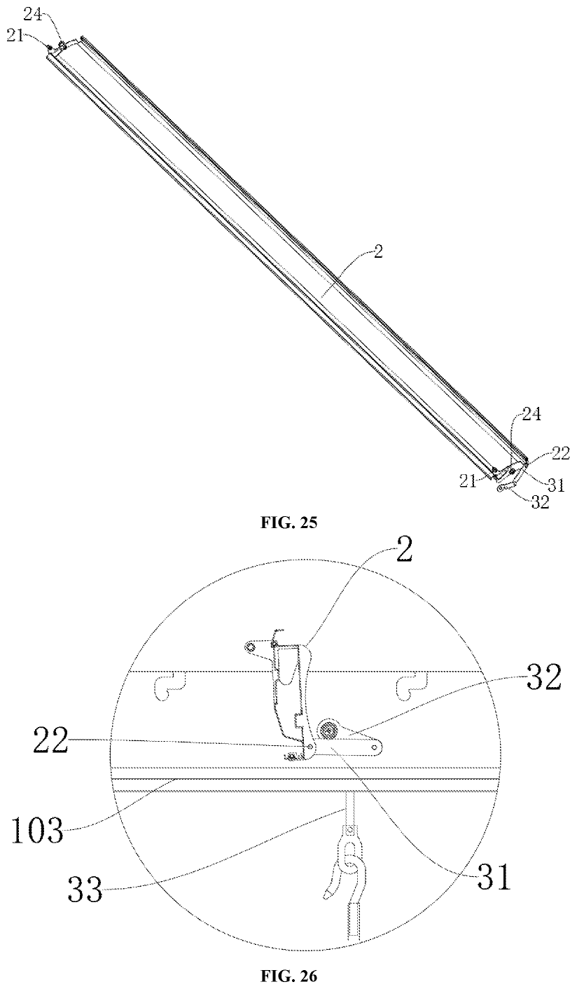

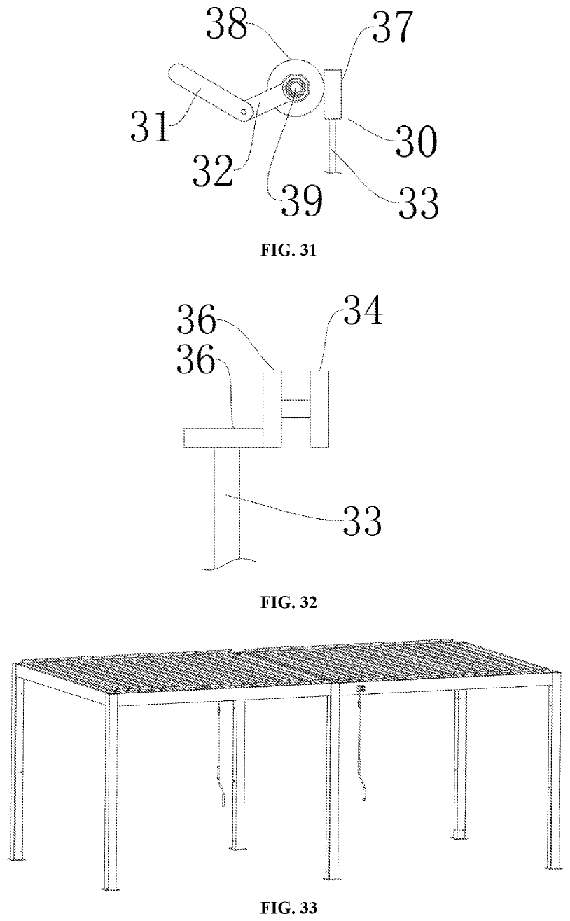

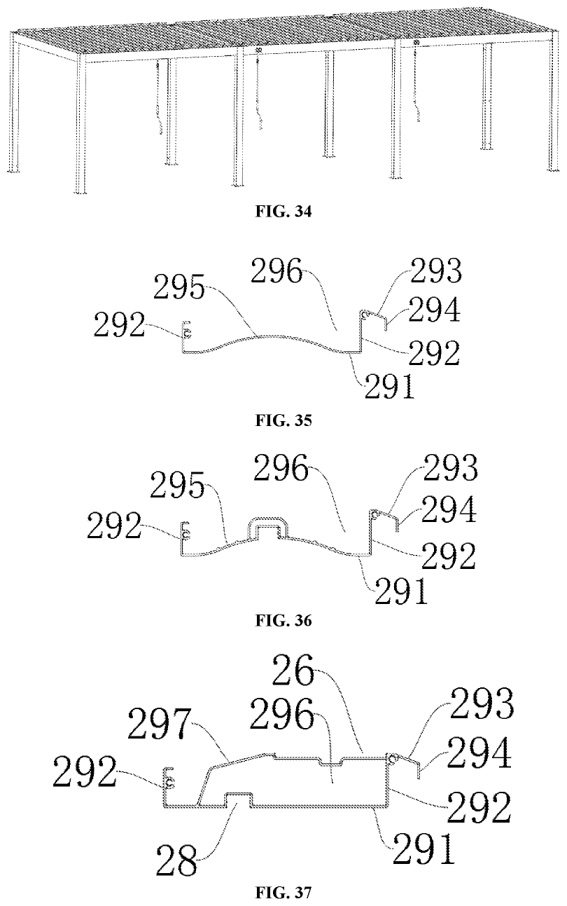

As shown in FIGS. 23-27, 30-32 and 39, the louver flipping driving device 3 includes a first connecting rod 31, a second connecting rod 32 and a driving mechanism 30 for driving the first connecting rod 31 and the second connecting rod 32 to rotate, and the driving mechanism 30 is mounted on a second cross beam 103 on the driving side; the driving mechanism 30 includes a gear drive group or a turbine 38 and worm 37 drive group, one end of the first connecting rod 31 is hinged to the second hinge 22 on one louver 2, the other end thereof is hinged to one end of the second connecting rod 32, the other end of the second connecting rod 32 is connected to and fixed to an output end of the gear drive group or the turbine 38 and worm 37 drive group, and a driving handle 33 is provided on an input end of the gear drive group or the turbine 38 and worm 37 drive group; the driving handle 33 is operated to rotate so that the driving gear 34 of the gear drive group meshes and drives the driven gear 35 to rotate, and the driven gear 35 drives the output shaft 39 to rotate and drives the first connecting rod 31 and the second connecting rod 32 to be linked to drive the louvers 2 connected to the first connecting rod 31 to flip, and then all the louvers 2 are flipped through the linkage cooperation of the first link, and the driving gear 34 rotates and is driven by the driving handle 33 operating two parasol gears 36 which are in vertical mesh; or the driving handle 33 is operated to rotate so that the worm 37 of the turbine 38 worm gear 37 drive group meshes to drive the turbine 38 to rotate, and the turbine 38 drives the output shaft 39 to rotate to drive the first connecting rod 31 and the second connecting rod 32 to be linked to drive the louvers 2 connected to the first connecting rod 31 to flip, and then all the louvers 2 are flipped through the linkage cooperation of the first link.

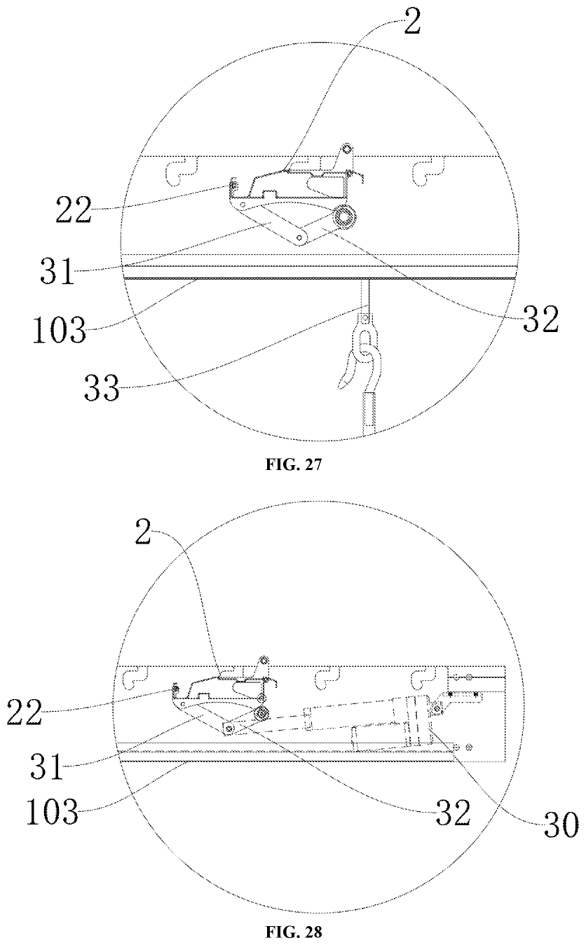

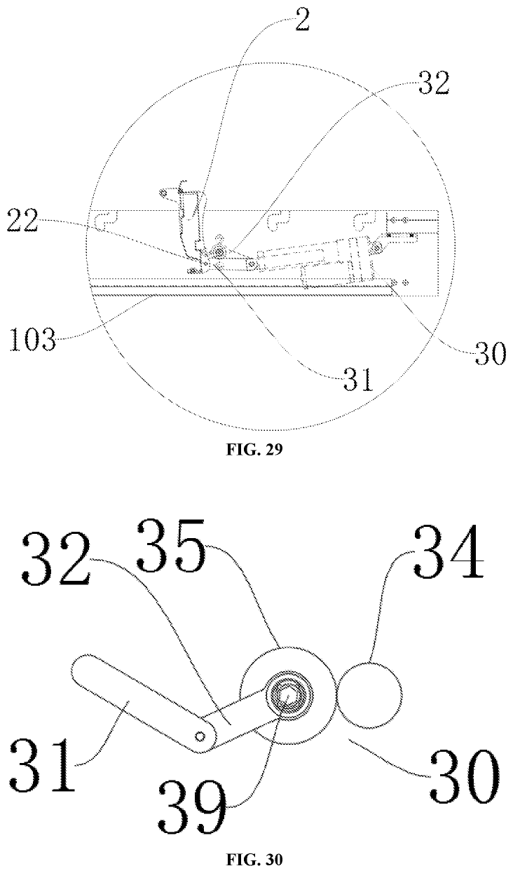

In another embodiment, as shown in FIGS. 28 and 29, the driving mechanism 30 includes a telescopic driving unit, where one end of the first connecting rod 31 is hinged to the second hinge 22 on one louver 2, and the other end thereof is hinged to one end of the second connecting rod 32 and a telescopic piece of the telescopic driving unit, respectively; the other end of the second connecting rod 32 is hinged to the second cross beam 103; the tail end of the telescopic driving unit is hinged to the beam body 11; in generally, a telescopic electric cylinder is used as the telescopic driving unit; when the telescopic rod of the telescopic electric cylinder performs an extension or retraction action, the first connecting rod 31 and the second connecting rod 32 perform a linkage action to flip the louvers 2 connected to the first connecting rod 31, and then all the louvers 2 are flipped by the linkage cooperation of the first link.

From the above, when the louvers 2 are flipped to a horizontal state, the louvers 2 cooperate with each other, an elongated concave portion and an elongated convex portion are respectively provided at the longitudinal side portions of the two adjacent louvers 2, and the longitudinal side portions of the two adjacent louvers 2 are stacked one on top of the other and the elongated convex portion cooperates within the elongated concave portion, so that the two adjacent louvers 2 are in a closed state; when each of the louvers 2 is flipped to the vertical or inclined state, the adjacent two louvers 2 are separated, so that there is a space exists between the adjacent two louvers 2.

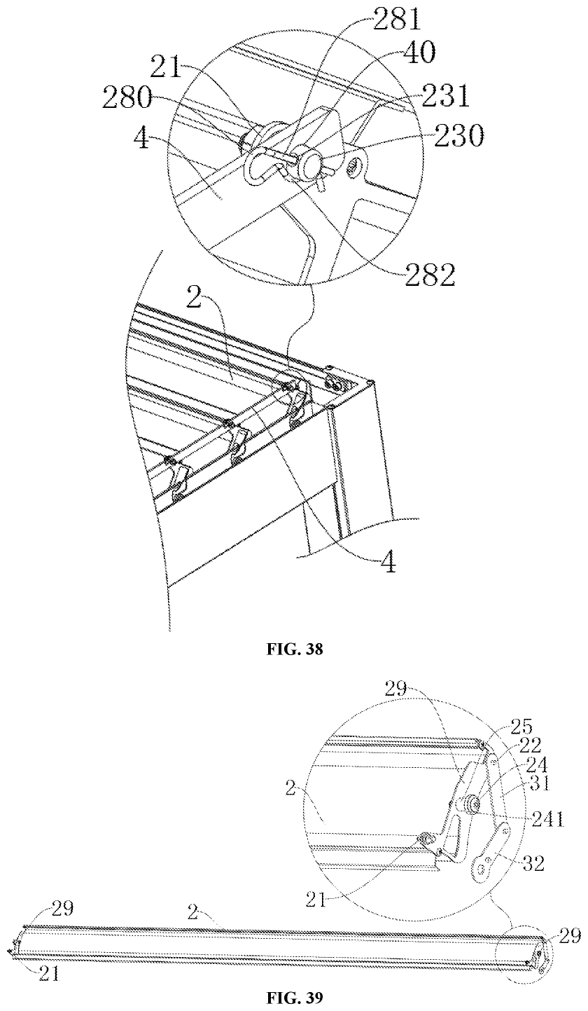

As shown in FIG. 38, a plurality of R-shaped pins 280 are further included, where each of the links 4 is provided with a plurality of hinge holes 40 linearly arranged along a length direction of both the links 4 at equal intervals, each of the first hinges 21 at two ends of each of the louvers 2 is fixed with a connecting column 230, each of the connecting columns 230 is provided with a pin hole 231, and each of the connecting columns 230 is respectively inserted into the plurality of hinge holes 40; a pin hole 231 is located outside the link 4 and exposed to the outside, a pin rod 281 of each R-shaped pin 280 is inserted into the pin hole 231 of each connecting column 230, and an elastomer ring 282 of each R-shaped pin 280 is hung on each connecting column 230 to limit the link 4 between the R-shaped pin 280 and the first hinge 21, and the R-shaped pin is made of steel wire bent, so that the link mounting is relatively convenient and the mounting efficiency is improved in the above-mentioned manner.

Further, as shown in FIGS. 35-37, the two ends of each louver 2 are respectively provided with a connecting board 29, and each louver 2 includes an elongated sheet 291 and two elongated baffles 292, the lower sides of the two elongated baffles 292 are connected to the elongated edges of the two opposite sides of the elongated sheet 291 to form an elongated groove 296, an upper end of an outer side face of one elongated baffle 292 is connected to an elongated tab 293 arranged in a downward slope, and the side of the elongated tab 293 away from the elongated baffle 292 is connected to a buckle 294. Each connecting board 29 is fixedly connected to the elongated baffle 292 or the elongated sheet 291 respectively by fixing fasteners, and each louver 2 is bent by a metal sheet to form an elongated sheet 291, two elongated baffles 292, an elongated tab 293 and a buckle 294; when a plurality of louvers are arranged side by side and are flipped to a horizontal state, the buckle is inserted into the elongated groove 296, and the elongated baffle adjacent to the buckle is inserted between the buckle and the elongated tab 293.

Preferably, an arc-shaped convex surface 295 is formed at a central portion of the elongated sheet 291, and the arc-shaped convex surface 295 functions to facilitate drainage, or
each louver 2 further includes an elongated cover sheet 297 having two opposite sides respectively connected to an elongated sheet 291 and an elongated baffle 292 having an elongated tab 293, the bottom surface of the elongated sheet 291 forms a stripped groove 28 for mounting the lighting device 203, and the elongated cover sheet 297 is concavely formed with an elongated mounting groove 26 for mounting a solar panel.

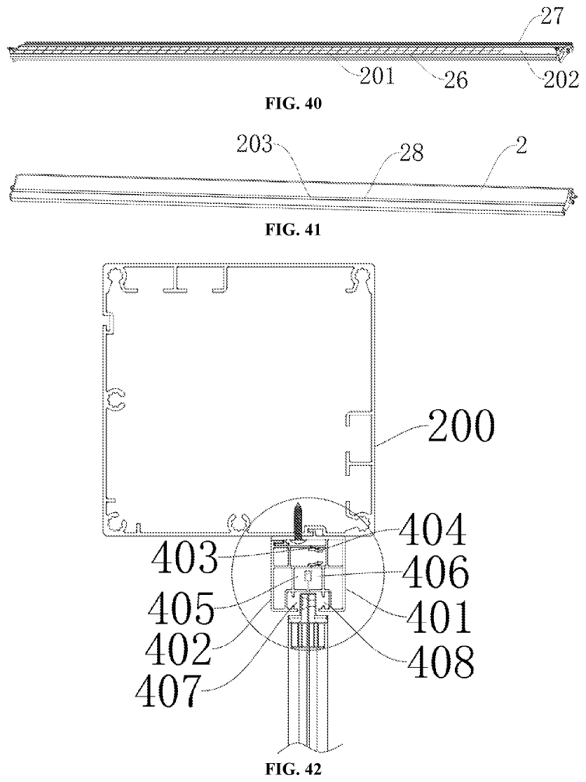

In another embodiment, as shown in FIGS. 37, 40 and 41, at least one louver is provided with a solar panel 201, a lighting device 203 and a storage battery 202, the back face of the louver 2 is provided with an elongated mounting groove 26, the solar panel 201 is mounted by laying in the elongated mounting groove 26, the storage battery 202 is mounted in a waterproof battery box which is mounted in a mounting cavity 27 of the louver, and the waterproof battery box is a known technical means in the art, which therefore is not described in detail herein; the lighting device 203 is a LED light bar, a front face of the louver is provided with a stripped groove 28, and the LED light bar is embedded and fixed in the stripped groove 28, the solar panel 201 is connected to the storage battery 202, and the storage battery 202 is connected to the lighting device 203.

What is claimed is:

1. A louvered awning structure, comprising an awning structure and a plurality of support columns, wherein the awning structure comprises a frame and a plurality of louvers arranged side by side, the plurality of support columns are mounted on the frame, so that the awning structure is in an overhead state due to being supported by the plurality of support columns, the frame comprises at least one first cross beam, and two oppositely arranged second cross beams, the plurality of louvers are located between the two second cross beam, two ends of each of the louvers are respectively close to inner walls of the two second cross beams; a plurality of pivot portions arranged at intervals are formed on the inner walls of the two second cross beams; shaft bodies at the two ends of each of the louvers are respectively pivotally connected to the pivot portions of the two second cross beams; each pivot portion on at least one of the second cross beams comprises an inlet passage and a pivot hole pivotally connected to the shaft body on the louver; and a communication passage respectively communicating with the inlet passage and the pivot hole, the communication passage is provided with a first communication port and a second communication port distributed up and down and arranged in a staggered manner, and the inlet passage and the pivot hole are respectively arranged at the first communication port and the second communication port, so that the inlet passage and the pivot hole are arranged in a staggered manner with respect to each other.

2. The louvered awning structure according to claim 1, wherein a side curtain is mounted on the first cross beam or at least one of the second cross beams.

3. The louvered awning structure according to claim 2, wherein a mount is mounted on a connecting side of the first cross beam or at least one of the second cross beams and is provided with a first clamping portion and a first connecting portion, a connecting groove is provided at the connecting side of the side curtain, and the connecting groove is provided therein with a second clamping portion and a second connecting portion, the mount is located in the connecting groove, the second clamping portion is located in a clamping region between the first clamping portion and the first cross beam or the second cross beam, the first clamping portion and the second clamping portion are snap-fitted with each other, and the first connecting portion is fixedly connected to the second connecting portion via a fastener.

4. The louvered awning structure according to claim 3, wherein a top end of each of the support columns is fixedly connected to both the end of the first cross beam and the end of the second cross beam, each of the support columns is provided with a fixed connecting portion, and the first cross beam and the second cross beam are respectively arranged perpendicular to the support columns.

5. The louvered awning structure according to claim 4, wherein the end of the first cross beam and the end of the second cross beam are placed on an end face of the top end of the support column, and the top end of the support column is provided with a first connecting board and a second connecting board arranged perpendicular to each other, the end of the first cross beam and the end of the second cross beam are both provided with connecting faces, the connecting face of the first cross beam is close to an inner wall of the first connecting board, the connecting face of the second cross beam is close to an inner wall of the second connecting board, the inner wall of the first connecting board and the inner wall of the second connecting board are both provided with a limiting slot, a connecting block is inserted into each of the limiting slots, and a limiting protrusion for limiting the connecting block is formed on an edge of a notch of each of the limiting slots, the end of the first cross beam is connected to the connecting block on the first connecting board via a fastener, and the end of the second cross beam is connected to the connecting block on the second connecting board via the fastener respectively to fix the end of the first cross beam and the end of the second cross beam at the top end of the support column, and the connecting face of the first cross beam is arranged in parallel with the first connecting board; and the connecting face of the second cross beam is arranged in parallel with the second connecting board.

6. The louvered awning structure according to claim 4, wherein a guide rail is provided on a side face of the support column facing the side curtain, and the guide rail is arranged in a vertical shape, a positioning protrusion is provided on the side of the guide rail facing the support column, a positioning groove is provided on the side of the support column facing the side curtain, the positioning protrusion fits into the positioning groove, the side curtain is a pull-type rolling curtain having a side of a curtain body inserted into a rail slot of the guide rail, and the guide rail is connected to the fixed connecting portion via the fastener.

7. The louvered awning structure according to claim 6, wherein a clamping groove is formed on a side inner wall of the positioning groove, a clamping block is formed on a front face of the positioning protrusion facing the clamping groove and is snap-fitted into the clamping groove, and an opening width of the clamping groove is greater than the distance between the end of the clamping block and a back face of the positioning protrusion.

8. The louvered awning structure according to claim 6, wherein the guide rail comprises a first guide and a second guide, a first snap, a first half groove and a second half groove are provided at an inner side of the first guide, a second snap corresponding to the position of the first snap, a third half groove corresponding to the position of the first half groove and a fourth half groove corresponding to the position of the second half groove are provided at an inner side of the second guide, wherein the inner side of the first guide and the inner side of the second guide are in contact with or close to each other, and the first snap and the second snap are fastened to each other, and the first half groove and the third half groove are assembled to form a rail slot; the second half groove and the fourth half groove are assembled to form a positioning elongated groove, an end of a strip of a bottom edge of the curtain body of the pull-type rolling curtain is inserted into the positioning elongated groove, and the positioning protrusion is provided on the first guide or the second guide.

9. The louvered awning structure according to claim 8, wherein a first positioning body is provided on the first guide, a second positioning body is provided on the second guide, the first positioning body comprises a positioning board, a first positioning insert block and a first positioning insert slot, the second positioning body comprises a second positioning insert block and a second positioning insert slot, the positioning board is located above the second guide, the first positioning insert block is correspondingly inserted into the second positioning insert slot, and the second positioning insert block is correspondingly inserted into the first positioning insert slot.

10. The louvered awning structure according to claim 3, wherein the side curtain is a venetian blind, a vertical side face of a frame body on the venetian blind is connected to the fixed connecting portion on the support column via the fastener, a connecting groove is provided at a top face of the frame body on the venetian blind, or
the side curtain is a rail-type curtain having a rail provided with a connecting groove and a cloth curtain hanging rail, and an upper side of the cloth curtain of the rail-type curtain is slidably mounted on the cloth curtain hanging rail via hooks.

11. The louvered awning structure according to claim 1, wherein the communication passage is provided horizontally along a length direction of the second cross beam or the communication passage is provided obliquely; an upper side inner wall of the communication passage is located above the pivot hole, and a lower side inner wall of the communication passage is located below the inlet passage; a recess is formed on the pivot hole at one side of the lower side inner wall of the communication passage to cooperate with the shaft body on the louver, and a blocking portion is formed on an upper side of the recess, and the inner wall of the pivot hole is provided in a circular arc shape, so that the recess is a circular arc-shaped recess.

12. The louvered awning structure according to claim 1, further comprising two links and a louver flipping driving device, wherein the two links are arranged along a length direction of the second cross beam and are respectively located above two ends of each of the louvers, a first hinge at the two ends of each of the louvers is respectively hinged with the two links, and the louver flipping driving device is hinged with a second hinge on one louver of the louvered awning; the positions of the first hinges at two ends of each of the louvers are arranged corresponding to each other, and the first hinges at two ends of each of the louvers are arranged offset from a central axis thereof in the width direction of the louvers.

13. The louvered awning structure according to claim 1, wherein the at least one louver is provided with a solar panel, a lighting device, and a storage battery, the solar panel is mounted at a back face of the louver, the storage battery is mounted in the mounting cavity of the louver, the lighting device is mounted at a front face of the louver, the solar panel is connected to the storage battery, and the storage battery is connected to the lighting device.

14. The louvered awning structure according to claim 12, further comprising a plurality of R-shaped pins, wherein each of the links is provided with a plurality of hinge holes linearly arranged along a length direction of both the links at equal intervals, each of the first hinges at two ends of each of the louvers is fixed with a connecting column, each of the connecting columns is provided with a pin hole, and each of the connecting columns is respectively inserted into the plurality of hinge holes; a pin hole is located outside the link and exposed to the outside, a pin rod of each R-shaped pin is inserted into the pin hole of each connecting column, and an elastomer ring of each R-shaped pin is hung on each connecting column to limit the link between the R-shaped pin and the first hinge.

15. The louvered awning structure according to claim 1, wherein a limiting body is provided on the shaft body pivotally connected into the pivot hole via the inlet passage and the communication passage on the louver, or
a rolling sleeve or a rolling wheel is sleeved on the shaft body pivotally connected into the pivot hole via the inlet passage and the communication passage on the louver, the rolling sleeve or the rolling wheel is movably mounted in the pivot hole, a limiting body is provided on the rolling sleeve or the rolling wheel, and a limiting member is mounted at the end of the shaft body pivotally connected into the pivot hole via the inlet passage and the communication passage on the louver to limit the rolling sleeve or the rolling wheel on the shaft body; and the limiting body is located outside a mounting piece.
